(19) United States
(12) Patent Application Publication
(10) Pub. No.: US 2010/0098334 A1
(43) Pub. Date: Apr. 22, 2010

(54) COLOR-INTERPOLATION DEVICE AND IMAGE PROCESSING SYSTEM

(75) Inventor: Takeshi FUKUTOMI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/643,158

(22) Filed: Dec. 21, 2009

Related U.S. Application Data
(63) Continuation of application No. PCT/JP2008/061360, filed on Jun. 20, 2008.

(30) Foreign Application Priority Data
Jun. 22, 2007 (JP) 2007-165165

(51) Int. Cl. G06K 9/40

(52) U.S. Cl. 382/167

(57) ABSTRACT

Provided is a color-interpolation device including: an interpolation processor that generates a first interpolated image signal and a second interpolated image signal by respectively performing first interpolation processing and second interpolation processing on a color image signal formed of pixels having a missing color component; an evaluation-value calculating unit that calculates, for each pixel, an evaluation value for specifying a specified region which becomes the target of the first interpolation processing; a region defining unit that defines the specified region on the basis of the evaluation value; and an interpolation-process determining unit that generates the interpolated color image signal by extracting the image signal of the specified region from the first interpolated image signal, extracting the image signal of the region other than the specified region from the second interpolated image signal, and combining the extracted image signals.

### CROSS REFERENCE TO RELATED APPLICATIONS

This application is a continuation application of PCT/JP2008/061360 filed on Jun. 20, 2008 and claims the benefit of Japanese Applications No. 2007-165165 filed in Japan on Jun. 22, 2007, the entire contents of each of which are hereby incorporated by their reference.

### BACKGROUND OF THE INVENTION

1. Field of the Invention

The present invention relates to image-processing systems adaptable to a device for displaying, inputting, and outputting digitally converted images, such as a digital camera and a video camera, and in particular, relates to a color-interpolation device that generates an interpolated color image signal by interpolating missing color components for a color image signal formed of pixels having missing color components.

2. Description of Related Art

An image signal that is output from a single-chip image-acquisition device used for a digital camera and the like only has information of one color component for each pixel. Therefore, it is necessary to perform interpolation processing for interpolating for missing color components in each pixel to generate a color digital image. Such interpolation processing for interpolating for missing color components is similarly required in devices that use a two-chip image-acquisition device or a three-chip pixel shifting image-acquisition device.

When uniform interpolation processing is performed over the whole image, there is a problem in that false colors are caused at edge portions etc. of the image. To deal with such a problem, a technique has been proposed that suppresses the occurrence of false colors in the vicinity of the edges of the image by adaptably changing filter factors of an interpolation filter on the basis of luminance information of surrounding pixels (for example, see Japanese Unexamined Patent Application, Publication No. 2000-23174).

Also, a technique has been proposed that, as shown in FIG. 3 for example, avoids Moire fringes and maintains resolution in straight line portions of an image by performing interpolation processing using filter factors having a frequency characteristic whereby the response is sharply lowered near the Nyquist frequency (for example, see Japanese Unexamined Patent Application, Publication No. 2006-13558).

### BRIEF SUMMARY OF THE INVENTION

A first aspect of the present invention is a color-interpolation device that generates an interpolated color image signal by interpolating a missing color component for a color image signal formed of pixels having a missing color component, including: an interpolation processor that generates a first interpolated image signal and a second interpolated image signal by respectively performing first interpolation processing and second interpolation processing on the color image signal; an evaluation-value calculating unit that calculates, for each pixel, an evaluation value for specifying a specified region which becomes the target of the first interpolation processing; a region defining unit that defines the specified region on the basis of the evaluation value; and an interpolation-process determining unit that generates the interpolated color image signal by extracting the image signal of the specified region from the first interpolated image signal, extracting the image signal of the region other than the specified region from the second interpolated image signal, and combining the extracted ima signals.

A second aspect of the present invention is a color-interpolation device that generates an interpolated color image signal by interpolating a missing color component for a color image signal formed of pixels having a missing color component, including: an evaluation-value calculating unit that calculates, for each pixel, an evaluation value for specifying a specified region from the color image signal; region defining unit that defines specified region on the basis of the evaluation value; an interpolation-process determining unit that selects first interpolation processing to be used for the specified region and that selects second interpolation processing to be used for a region other than the specified region; and an interpolation processor that generates the interpolated color image signal by performing the first interpolation processing on the specified region of the color image signal and by performing the second interpolation processing on the region other than the specified region.

A third aspect of the present invention is a color interpolation method for generating an interpolated color image signal by interpolating a missing color component for a color image signal formed of pixels having a missing color component, including: an interpolation processing step of generating a first interpolated image signal and a second interpolated image signal by respectively performing first interpolation processing and second interpolation processing on the color image signal; an evaluation-value calculating step of calculating, for each pixel, an evaluation value for specifying a specified region which becomes the target of the first interpolation processing; a region defining step of defining the specified region on the basis of the evaluation value; and an interpolation-process determining step of generating the interpolated color image signal by extracting the image signal of the specified region from the first interpolated image signal, extracting the image signal of the region other than the specified region from the second interpolated image signal, and combining the extracted image signals.

A fourth aspect of the present invention is a color interpolation method for generating an interpolated color image signal by interpolating a missing color component for a color image signal formed of pixels having a missing color component, including: an evaluation-value calculating step of calculating, for each pixel, an evaluation value for specifying a specified region from the color image signal; a region defining step of defining a specified region on the basis of the evaluation value; an interpolation-process determining step of selecting first interpolation processing to be used for the specified region and selecting second interpolation processing to be used for a region other than the specified region; and an interpolation processing step of generating the interpolated color image signal by performing the first interpolation processing on the specified region of the color image signal and by performing the second interpolation processing on the region other than the specified region.

A fifth aspect of the present invention is a computer-readable recording medium for recording a color interpolation program that generates an interpolated color image signal by interpolating a missing color component for a color image signal formed of pixels having a missing col component, wherein the color interpolation program causes a computer to execute: an interpolation processing step of generating a first interpolated image signal and a second interpolated image signal by performing first interpolation processing and second interpolation processing on the color image signal, respectively; an evaluation-value calculation step of calculating, for every pixel, an evaluation value for specifying a specified region that becomes the target of the first interpolation processing; a region defining step of defining the specified region based on the evaluation value; an interpolation-process determining step of extracting the image signal of the specified region from the first interpolated image signal; extracting an image signal of a region other than the specified region from the second interpolated image signal; and generating the interpolated color image signal by combining the extracted image signals.

A sixth aspect of the present invention is a computer-readable recording medium for recording a color interpolation program that generates an interpolated color image signal by interpolating a missing color component for a color image signal formed of pixels having a missing color component, wherein the color interpolation program causes a computer to execute: an evaluation-value calculation step of calculating, for every pixel, an evaluation value for specifying a specified region from the color image signal; a region defining step of defining the specified region based on the evaluation value; an interpolation-process determining step of selecting first interpolation processing to be used for the specified region and selecting second interpolation processing to be used for the region other than the specified region; and an interpolation processing step of generating the interpolated color image signal by performing the first interpolation processing on the specified region of the color image signal and performing the second interpolation processing on the region other than the specified region.

### BRIEF DESCRIPTION OF THE SEVERAL VIEWS OF THE DRAWINGS

FIG. 1 is a diagram showing, in outline, the overall configuration of an image processing system according to a first embodiment of the present invention.

FIG. 2 is a functional block diagram of a color-interpolating unit shown in FIG. 1.

FIG. 3 is a diagram showing an example of a first interpolation filter and a second interpolation filter.

FIG. 4 is a functional block diagram of a color-interpolating unit according to a second embodiment of the present invention.

FIG. 5 is a functional block diagram of a color-interpolating unit according to a third embodiment of the present invention.

FIG. 6 is a diagram showing an example of a combining ratio.

FIG. 7 is a functional block diagram of a color-interpolating unit according to a fourth embodiment of the present invention.

FIG. 8 is a diagram showing an example of a surrounding region.

FIG. 9 is a diagram showing an example of a surrounding region.

FIG. 10 is a functional block diagram of a color interpolating unit according to a fifth embodiment of the present invention.

### DETAILED DESCRIPTION OF THE INVENTION

An embodiment of a color-interpolation device and an image processing system according to the present invention will be described below with reference to the drawings.

### First Embodiment

In each of the following embodiments, a digital camera will be described as an example of the image processing system. Also, a color-interpolation device of the present invention is built into the digital camera and functions as color-interpolating unit performing interpolation processing.

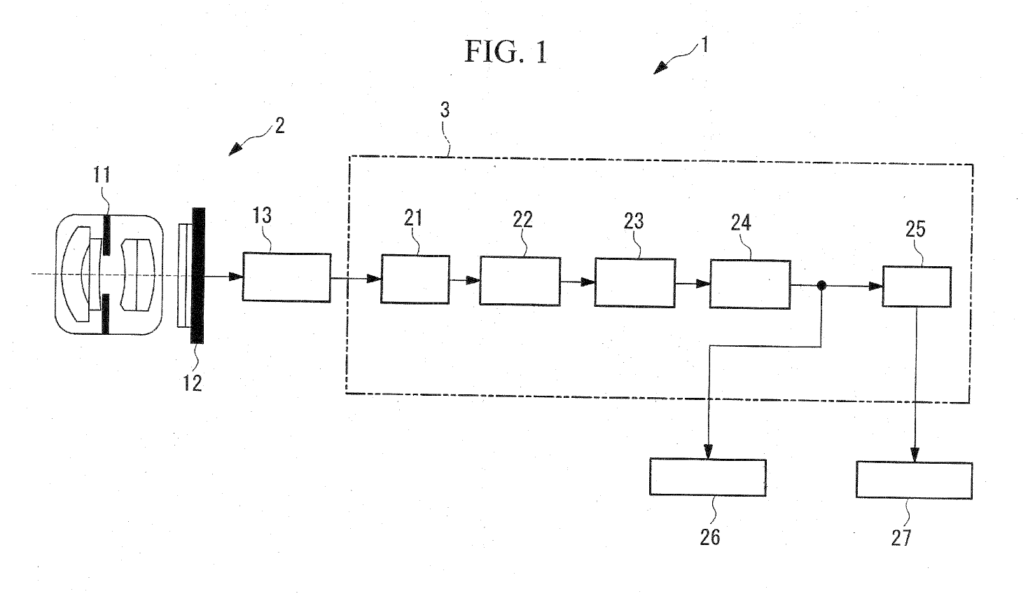

FIG. 1 is a block diagram showing, in outline, the configuration of a digital camera according to a first embodiment of the present invention.

As shown in FIG. 1, a digital camera 1 according to this embodiment is provided with an image-acquisition device 2 and an image-processing device 3. The image-acquisition device is configured to have a lens 11, a solid-state image-acquisition element 12, an image-acquisition signal processing unit 13 and so forth. The image-processing device 3 is configured to have an A/D converter 21, a first signal-processing unit 22, a color-interpolating unit (color-interpolation device) 23, a second signal-processing unit 24, a compressing unit 25, a display unit 26, a storage medium 27, and so forth. The storage medium 27 is attachable to and detachable from the main body of the digital camera 1.

The solid-state image-acquisition element 12 is an image-acquisition element such as, for example, a CCD or SMOS device, and a single-chip RGB Bayer array color filter (not shown) is mounted thereon. The RGB Bayer array has a configuration in which G (green) filters are arranged in a checkerboard-like pattern, and R (red) filters and B (blue) filters are arranged alternately in every line. Therefore, the image signal that is output from the solid-state image-acquisition element 12 will be a signal having a pixel value of any one color of an B (red) component, a G (green) component, or a B (blue) component per pixel.

Such an image signal is input to the image-acquisition signal processing unit 13 in, for example, the color sequence C, R, G, R . . . , or the color sequence B, G, B, G . . . . In the following description, such an image signal is referred to as a Bayer-array image signal.

The image-acquisition signal processing unit 13 performs processing such as CDS (Correlated Double Sampling)/differential sampling, as well as adjustment of analog gain, on the Bayer-array image signal and outputs the processed Bayer-array image signal to the image-processing device 3.

In the image-processing device 3, the A/D converter 21 converts the Bayer-array image signal into a digital signal and outputs it. The first signal-processing unit 22 performs processing such as white balance processing on the Bayer-array image signal and outputs it. The color-interpolating unit 23, which is the main subject matter of the present invention, generates a color image signal having R, G, and B color information in each pixel by performing the interpolation processing, described below, on the Bayer-array image signal and outputs this color image signal. The second signal-processing unit 24 performs color interpolation processing, γ interpolation processing, and the like on the color image signal from the color-interpolating unit 23 and outputs the processed color image signal to the storage medium 27 via the display unit 26 and the compressing unit 25.

Next, the operation of the digital camera 1 according to this embodiment will be described briefly. The processing in each unit described below is realized by operating each processing unit under the control of a system controller, which is not shown.

When a shutter button (not shown) provided on the digital camera main body is pressed by a user, first, an optical image formed through the lens 11 is photoelectrically converted in the solid-state image-acquisition element 12, and a Bayer-array image signal is generated. After being subjected to processing such as CDS (Correlated Double Sampling)/differential sampling, as well as adjustment of the analog gain, in the image-acquisition signal processing unit 13, this Bayer-array image signal is converted to a digital signal in the A/D converter 21 in the image-processing device 3 and is subjected to predetermined image processing, such as white balance processing, by the first signal-processing unit 22. The Bayer-array image signal output from the first signal-processing unit 22 serves as the color image signal having RGB three-color information in each pixel in the color-interpolating unit 23. The color image signal is subjected to color interpolation processing, γ interpolation processing, etc. in the second signal-processing unit 24, and the processed color image signal is displayed on the display unit 26 and is saved in the storage medium 27 via the compressing unit 25.

Next, the details of the above-described color-interpolating unit 23 will be described with reference to the drawings.

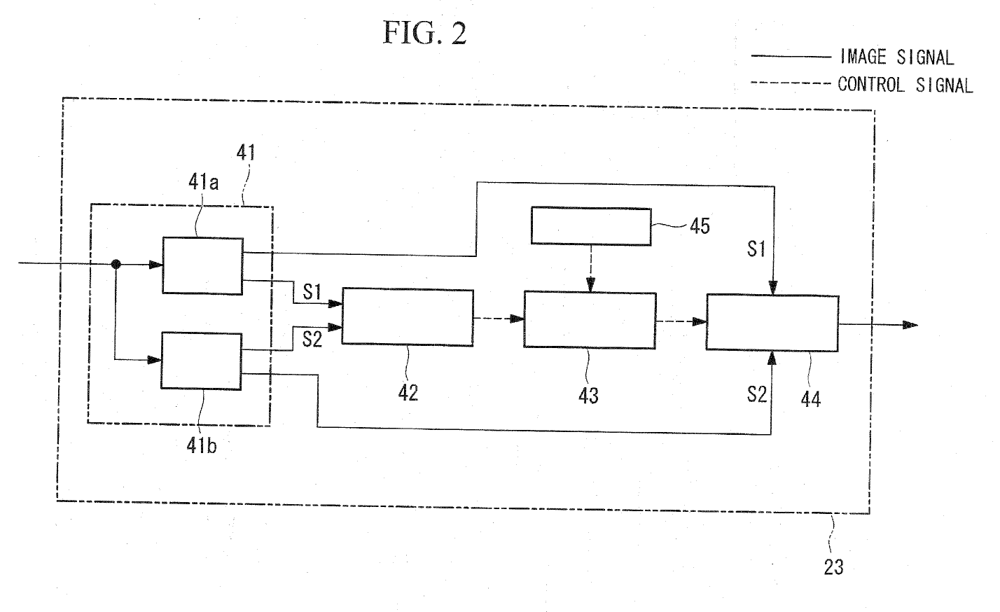

FIG. 2 is a functional block diagram of the color-interpolating unit 23 according to this embodiment. As shown in FIG. 2, the color-interpolating unit 23 is configured to have an interpolation processor 41, an evaluation-value calculating unit 42, a region defining unit 43, an interpolation-process determining unit 44, and a threshold-value input unit 45. Also, the interpolation processor 41 is configured to have a first signal-interpolating unit 41a and a second signal-interpolating unit 41b. Note that each unit forming the color-interpolating unit 23 may be configured equivalently of a CPU and a memory in which a program controlling the operation of the CPU is stored.

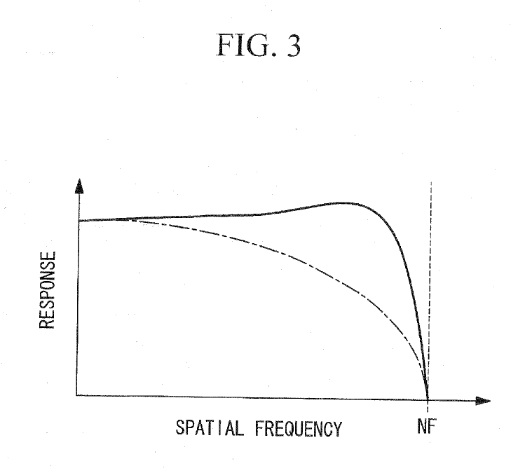

As shown by the solid line in FIG. 3, the above-described first signal-interpolating unit 41a is provided with a first interpolation filter configured with a filter factor having a frequency characteristic whereby an approximately constant response is maintained from a low frequency to just before the Nyquist frequency NF of the image, and the response declines from just before the Nyquist frequency NF to the Nyquist frequency NF. The first signal-interpolating unit 41a performs the interpolation processing on the Bayer-array image signal using the first interpolation filter and outputs the processed signal as a first interpolated image signal Note that in FIG. 3, the horizontal axis shows spatial frequency and the vertical axis shows response.

As shown by the one-dot chain line in FIG. 3, the above-described second signal-interpolating unit 41b has a second interpolation filter configured with a filter factor having a frequency characteristic whereby the response declines from a low frequency to the Nyquist frequency NF more gradually than the filter factor of the above-described first interpolation filter. The second signal-interpolating unit 41b performs the interpolation processing on the Bayer-array image signal using the second interpolation filter and outputs the processed signal as a second interpolated image signal S2.

The first interpolated image signal S1 and the second interpolated image signal S2 are input to the evaluation-value calculating unit 42 and the interpolation-process determining unit 44. The evaluation-value calculating unit 42 compares the first interpolated image signal S1 with the second interpolated image signal S2 for every pixel, calculates the absolute value |S1−S2| of the difference between the pixel values, and outputs this value to the region defining unit 43 as an evaluation value. The evaluation value is not, limited to this example and other evaluation values may be employed provided that the values are suitable for determining nonuniformities occurring in the edge portions of the image, such as a difference in chroma between the first interpolated image signal S1 and the second interpolated image signal S2.

The region defining unit 43 defines a specified region on the basis of the evaluation value from the evaluation-value calculating unit 42. Here, the specified region refers to a region that may appear to be nonuniform when the interpolation processing is performed by the first signal-interpolating unit 41a due to excessive partial enhancement of an edge in the sharp edge portions. Specifically, a threshold value TH input from the threshold-value input unit 45 with the evaluation value from the evaluation-value calculating unit 42 is compared. If the evaluation value is equal to or greater than the threshold value TH, then that pixel (i, j) is determined to be in the specified region, and a flag FLG(i, j) of the relevant pixel (i, j) is set to 1; and if the evaluation value is less than the threshold value TH, then it is determined to be in a region other than the specified region, and the flag FLG(i, j) of the relevant pixel (i, j) is set to 0. The region defining unit 43 outputs information of the flag FLG(i, j) of each pixel to the interpolation-process determining unit 44.

In the above-described region defining unit 43, the threshold value TH supplied from the threshold-value input unit 15 is set to any value ranging from 0 to a maximum threshold value THmax. Here, the maximum threshold value THmax is a maximum value which the signal to be input to the region defining unit 43 may take. Also, a configuration whereby the user can change the settings of the value of the threshold value TH is also possible.

The interpolation-process determining unit 44 selects the second interpolated image signal S2 for a pixel at which the flag FLG(i, j) is 1 and selects the first interpolated image signal S1 for a pixel at which the flag FLG(i, j) is 0; and combines these selected signals, thereby generating the final color image signal. This color image signal is output to the second signal-processing unit 24 (see FIG. 1) in the subsequent stage.

As described above, with the digital camera 1 and the color-interpolating unit 23 according to this embodiment, it is possible to select suitable interpolation processing according to the characteristic of the pixels. Accordingly, it is possible to obtain an image in which nonuniformity that may occur in sharp edge portions is eliminated and the resolution is maintained, because, for example, the pixels that would be displayed as a sharp edge if the first interpolation filter were used are replaced by the second interpolated image signal generated using a more moderate second interpolation filter than the first interpolation filter.

### Second Embodiment

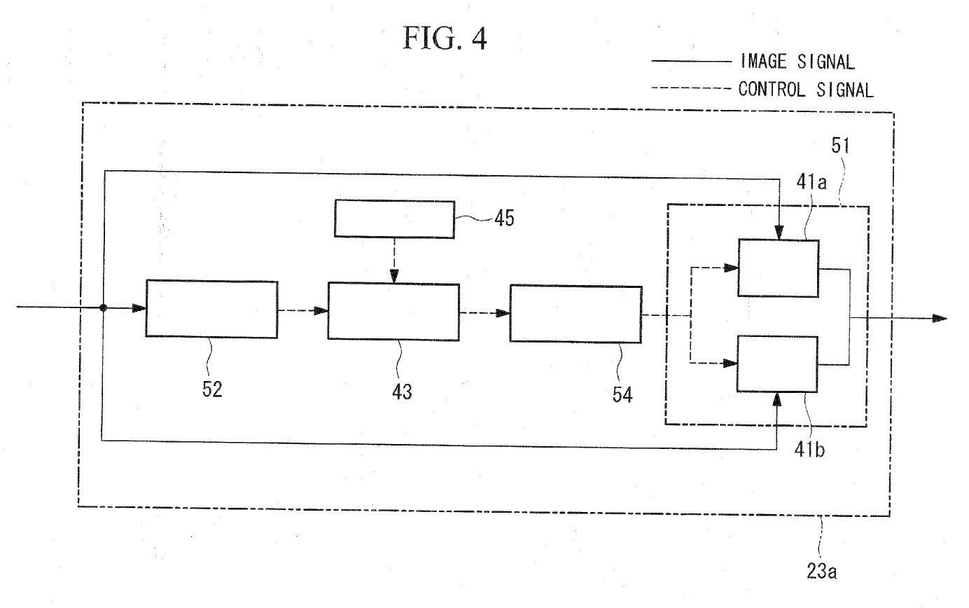

Next, a second embodiment of the present invention will be described using FIG. 4.

As shown in FIG. 4, in the digital camera according to this embodiment, the configuration of the color-interpolating unit 23a differs from that of the color-interpolating unit 23 of the digital camera 1 according to the first embodiment. In the following description of the color-interpolating unit 23a of this embodiment, a description of features that are the same as those of the first embodiment will be omitted, and the differences will be mainly described.

As shown in FIG. 4, in the color-interpolating unit 23a according to this embodiment, an interpolation processor 51 is disposed in the subsequent stage of an interpolation-process determining unit 54.

In the following, the operation of the color-interpolating unit 23a having such a configuration will be described.

The Bayer-array image-signal output from the first signal-processing unit 22 shown in FIG. 1 is input to an evaluation-value calculating unit 52 and a first signal-interpolating unit 41a and a second signal-interpolating unit 41b of the interpolation processor 51 in FIG. 4, respectively.

The evaluation-value calculating unit 52 is provided with a filter capable of calculating a value equivalent to the difference between the first interpolated image signal S1 that is obtained as a result of the interpolation processing performed on the Bayer-array image signal by the first signal-interpolating unit 41a using the first interpolation filter and the second interpolated image signal S2 that is obtained as a result of the interpolation processing performed on the Bayer-array image signal by the second signal-interpolating unit 41b using the second interpolation filter. The evaluation-value calculating unit 52 obtains an evaluation value substantially comparable with that in the first embodiment by filtering the Bayer-array image signal that is input from the first signal-processing unit 22 (see FIG. 1) using this filter and outputs this evaluation value to the region defining unit 43.

The region defining unit 43 sets FLG(i, j) of each pixel (i, j) by a similar process to that in the above-described first embodiment and outputs this information to the interpolation-process determining unit 54.

The interpolation-process determining unit 54 selects the interpolation processing to be used for each pixel in accordance with the information in the flag FLG(i, j). Specifically, the second signal-interpolating unit 41b is selected for the pixels at which the flag FLG(i, j) is 1, and the first signal-interpolating unit 41a is selected for the pixels at which the flag FLG(i, j) is 0, and the selected information is output to the interpolation processor 51.

Accordingly, in the interpolation processor 51, smooth interpolation processing is performed on the pixels at which the flag FLG(i, j) is 1 (i.e., the specified region) by the second signal-interpolating unit 41b; and interpolation processing by which the edge portions are enhanced is performed on the region other than the specified region by the first signal-interpolating unit 41a. Then, by combining these signals after the interpolation processing, the color image signal is generated and is output to the second signal-processing unit 24 (see FIG. 1) in the subsequent stage.

### Third Embodiment

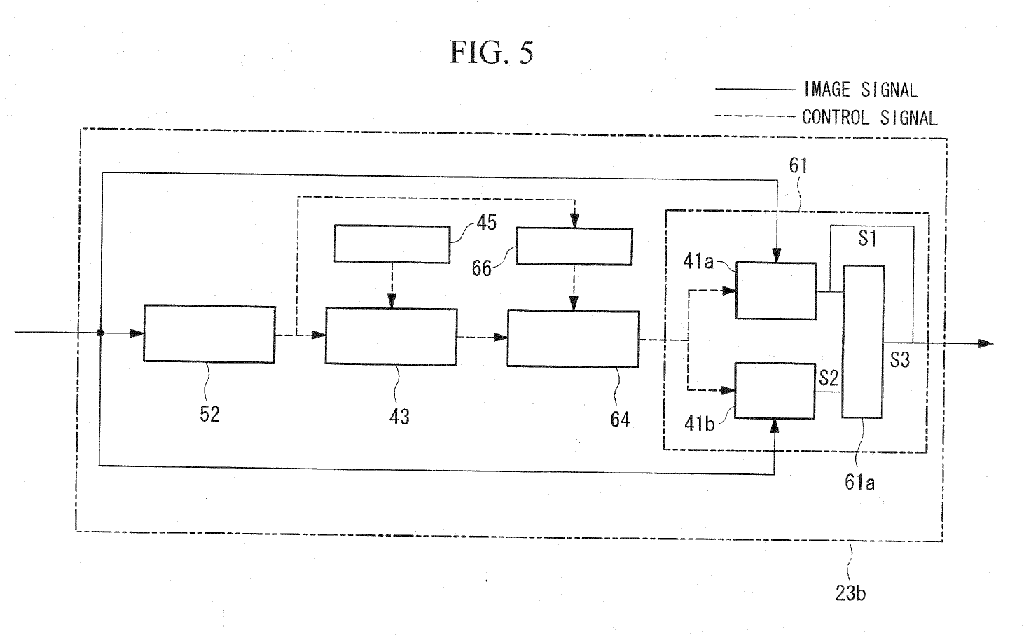

Next, a third embodiment of the present invention will be described using FIG. 5.

As shown in FIG. 5, in the digital camera of this embodiment, the configuration of the color-interpolating unit 23b differs from that of the digital camera according to the above-described second embodiment. In the following description of the color-interpolating unit 23b of this embodiment, a description of features that are the same as those of the second embodiment will be omitted, and the differences will be mainly described.

As shown in FIG. 5, a color-interpolating unit 23b according to this embodiment is provided with a coefficient determining unit 66 that inputs a weighted summation coefficient, to an interpolation-process determining unit 64. Also, an interpolation processor 61 is provided with a combining unit 61a.

In the following, the operation of the color-interpolating unit 23b having such a configuration will be described.

First, the evaluation-value calculating unit 52 calculates an evaluation value using a filter in a similar manner as in the above-described second embodiment and outputs this evaluation value to a region defining unit 43 and the coefficient determining unit 66.

The region defining unit 43 sets FLG(i, j) of each pixel (i, j) by a similar process to that in the above-described first embodiment and outputs this information to the interpolation-process determining unit 64.

The coefficient determining unit 66 determines the weighted summation coefficient. K for calculating a combining ratio in the combining unit 61a of the interpolation processor 61 in the subsequent stage in accordance with the magnitude of the evaluation value that is input from the evaluation-value calculating unit 52, using (1) below, and outputs this to the interpolation-process determining unit 64.

K=Evaluation Value/THmax (1)

The interpolation-process determining unit 64 selects the interpolation processing to be used for each pixel on the basis of the information in the flag FLG(i, j). Specifically, the first signal-interpolating unit 41a and the second signal-interpolating unit 41b are selected for the pixels at which the flag FLG(i, j) is 1; the first signal-interpolating unit 41a is selected for the pixels at which the flag FLG(i, j) is 0; and the selected information is output to the interpolation processor 61. Also, for the pixels at which the flag FLG(i, j) is 1, the weighted summation coefficient K of the relevant pixel input from the coefficient determining unit 66 is output together with the above-described selected information.

Accordingly, in the interpolation processor 61, the second interpolated image signal S2 generated by the second signal-interpolating unit 41b and the first interpolated image signal S1 generated by the first signal-interpolating unit 41a are output to the combining unit 61a for the pixels at which the flag FLG(i, j) is 1 (i.e., the specified region); and the signals are combined in the combining unit 61a based on the above-described weighted summation coefficient K. The combining unit 61a combines the first interpolated image signal 31 and the second interpolated image signal S2 according to the following expression (2) to generate a combined interpolated image signal S3.

S3=(1−K)*S1+K*S2 (2)

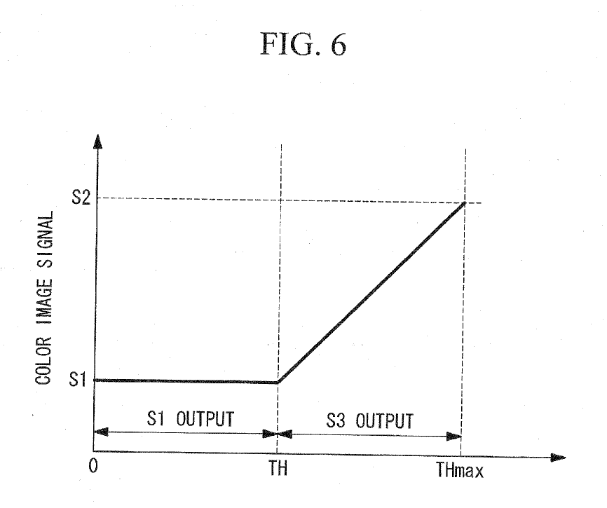

Here, since the weighted summation coefficient K is, as shown in (1) above, a value obtained by dividing the evaluation value by the maximum threshold value THmax, as shown in FIG. 6, the larger the evaluation value is, the smaller the combinational fraction of the first interpolated image signal S1 becomes, and the larger the combinational fraction of the second interpolated image signal S2 becomes.

Also, the interpolation processing is performed by the first signal-interpolating unit 41a for the pixels at which the flag FLG(i, j) is 0 (i.e., the region other than the specified region), and the first interpolated image signal S1 is generated. Then, by combining these processed signals, the color image signal is generated and is output to the second signal-processing unit 24 (see FIG. 1) in the subsequent stage.

As described-above, with the color-interpolating unit 23b and digital camera according to this embodiment, since the specified region is defined as the combined interpolated image signal S3 that is generated by combining the first interpolated image signal S1 and the second interpolated image signal S2 at the combining ratio based on the evaluation value, it is possible to obtain an image having smooth edges and a high resolution-maintaining effect.

### Fourth Embodiment

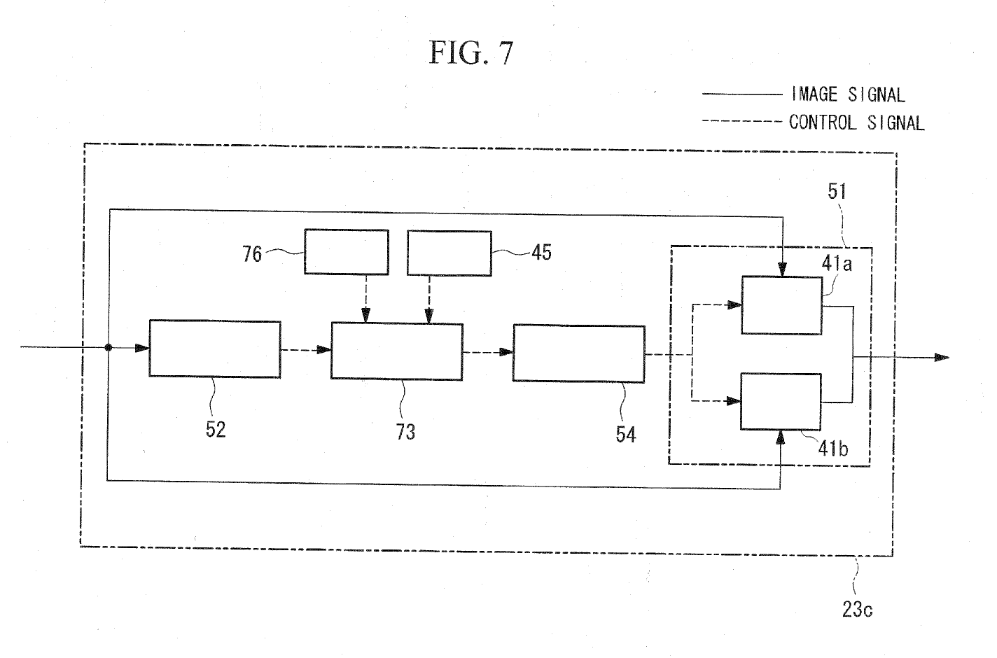

Next, a fourth embodiment of the present invention will be described using FIG. 7.

As shown in FIG. 7, in the digital camera of this embodiment, the configuration of the color-interpolating unit 23c differs from that of the color-interpolating unit 23a according to the above-described second embodiment. In the following description of the color-interpolating unit 23c according to this embodiment, a description of features are the same as those of the second embodiment will be omitted, and the differences will be mainly described.

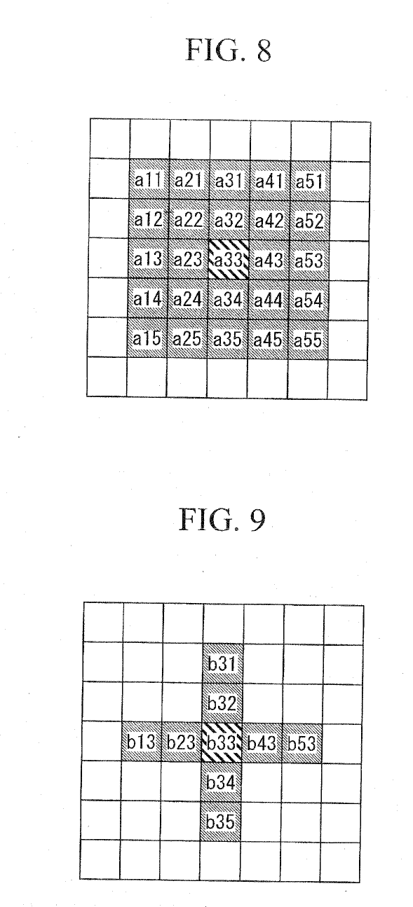

As shown in FIG. 7, the color-interpolating unit 23c according to this embodiment is provided with a selected-area input unit 76 that inputs the selected area to a region defining unit 73. The selected-area input unit 76 stores setting conditions of the surrounding regions, which are referenced by the region defining unit 73 when it sets the specified region. In FIG. 8 and FIG. 9, an example of the setting conditions of the surrounding regions is shown in FIG. 8 and FIG. 9, the pixel at the cross-hatched part is the pixel for which determination as to whether it is the specified region or not is carried out (the pixel of interest). In FIG. 8, the pixel of interest is taken as the center, and surrounding regions are set so as to surround the pixel of interest, and in FIG. 9, the pixel of interest is taken as the center, and the surrounding regions are set extending several pixels therefrom in the vertical direction and the horizontal direction, respectively. The selected-area input unit 76 inputs the setting conditions of the surrounding regions stored therein to the region defining unit 73.

In the following, the operation of the color-interpolating unit 23c having such a configuration will be described.

First, the evaluation-value calculating unit 52 calculates an evaluation value using a filter in a similar manner as in the above-described second embodiment and outputs this evaluation value to the region defining unit 73.

The region defining unit 73 compares the threshold value TH that is input from the threshold-value input unit 45 with the evaluation value from the evaluation-value calculating unit 52. If the evaluation value is equal to or greater than the threshold value TH, that pixel (i, j) is evaluated as being in the specified region, and the flag FLG(i, j) of the relevant pixel (i, j) is set to 1; if the evaluation value is less than the threshold value TH, it is evaluated as the region other than the specified region, and the flag FLG(i, j) of the relevant pixel (i, j) is set to 0. Further, when there are pixels (i, j) which have been determined to be in the specified region, the region defining unit 73 specifies the surrounding regions on the basis of the setting conditions of the surrounding regions that are input from the selected-area input unit 76, forcedly considers these pixels as being in the specified regions, and sets the flag FLG to 1. The region defining unit 73 sets the flag FLG for every pixel and, thereafter, outputs the information in the flag FLG(i, j) of each pixel to the interpolation-process determining unit 54.

The interpolation-process determining unit 54 selects, in a similar manner as in the above-described second embodiment, the interpolation processing to be used for each pixel on the basis of the information in the flag FLG(i, j) and outputs the selected information to the interpolation processor 51. Accordingly, in the interpolation processor 51, smooth interpolation processing is performed by the second signal-interpolating unit 41b for the pixels at which the flag FLG(i, j) is 1, and in the regions other than the specified region, interpolation processing by which the edge portions are enhanced is performed by the first signal-interpolating unit 41a. Thereafter, by combining the signals after these interpolation processes, the color image signal is generated and is output to the second signal-processing unit 24 (see FIG. 1) in the subsequent stage.

### Fifth Embodiment

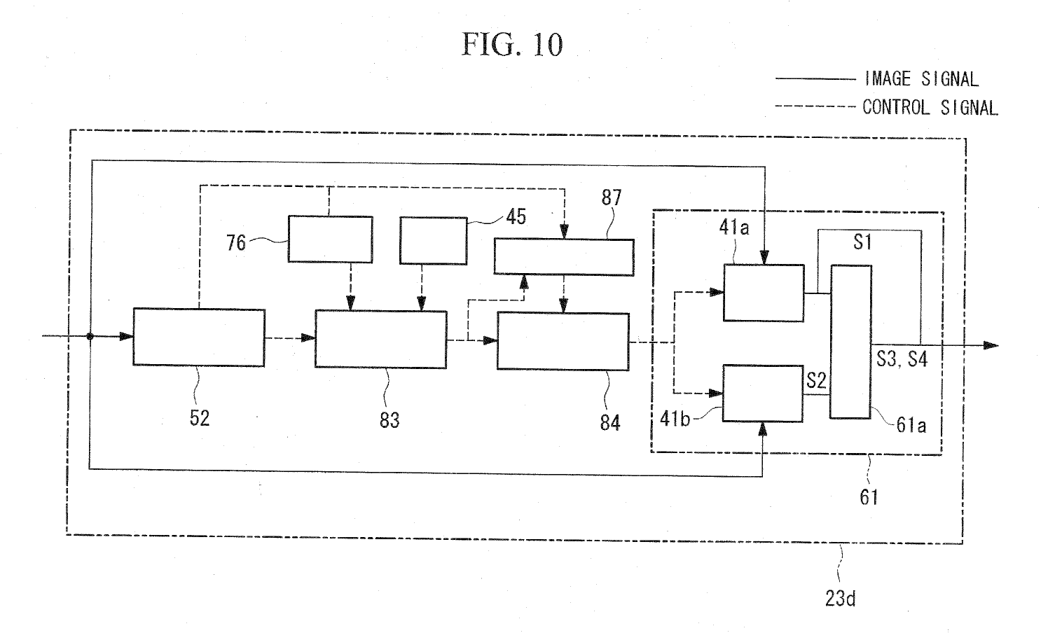

Next, a fifth embodiment of the present invention will be described using FIG. 10.

As shown in FIG. 10, in the digital camera according to this embodiment, the configuration of the color-interpolating unit 23d differs from that of the color-interpolating unit 23c according to the above-described fourth embodiment. In the following description of the color-interpolating unit 23d according to this embodiment, a description of features that are the same as those of the fourth embodiment will be omitted, and the differences will be mainly described.

As shown in FIG. 10, the color-interpolating unit 23d according to this embodiment is provided with a second coefficient determining unit 87 that inputs a weighted summation coefficient to an interpolation-process determining unit 84.

In the following, the operation of the color-interpolating unit 23d having such a configuration will be described.

First, the evaluation-value calculating unit 52 calculates an evaluation value using a filter in a similar manner as in the above-described second embodiment and outputs this evaluation value to a region defining unit 83 and the second coefficient determining unit 87.

The region defining unit 83 compares the threshold value TH input from the threshold-value input unit 45 with the evaluation value from the evaluation-value calculating unit 52. If the evaluation value is equal to or greater than the threshold value TH, that pixel (i, j) is evaluated as being in the specified region, and the flag FLG(i, j) of the relevant pixel (i, j) is set to 1; if the evaluation value is less than the threshold value TH, it is evaluated as being in the region other than the specified region, and the flag FLG(i, j) of the relevant pixel (i, j) is set to 0. Further, when there are pixels (i, j) which have been determined to be in the specified region, the region defining unit 83 specifies the surrounding regions on the basis of the setting conditions of the surrounding regions that are input from the selected-area input unit 76 and sets the flag FLG of these pixels to 3. The region defining unit 83 sets the flag FLG for every pixel and, thereafter, outputs information in the flag FLG(i, j) of each pixel to the interpolation-process determining unit 84.

The second coefficient determining unit 87 determines weighted summation coefficients M1 and K2 which indicate a combining ratio of the combining processing performed in an interpolation processor 61 in the subsequent stage in accordance with the magnitude of the evaluation value that is input from the evaluation-value calculating unit 52 and outputs this to the interpolation-process determining unit 84. Specifically, the second coefficient determining unit 87 determines the weighted summation coefficient K1 based on (3) below for the pixels at which the flag FLG(i, j) input from the region defining unit 83 is set to 1 and determines the weighted summation coefficient K2 based on (4) below for the pixels at which the flag FLG(i, j) input from the region defining unit 83 is set to 3.

K1=Evaluation Value/THmax (3)

K2=Evaluation Value/(THmax Grad) (4)

In expression (4), Grad=|(the evaluation value of the pixel of interest)−(the evaluation value of the relevant pixel)|.

Here, Grad indicates the gradient and is a value indicating the correlation between the pixel of interest and the relevant pixel belonging to the surrounding regions (hereinafter referred to as “surrounding pixel”). Note that with regard to Grad, different calculation methods from the above-described calculation method may be used, such as those using the distance from the pixel of interest, to the surrounding pixel as the value.

Accordingly, the weighted summation coefficient K1 will be calculated by using expression (3) above for the specified region, and the weighted summation coefficient. K2 will be calculated by using expression (4) above for the surrounding regions.

The interpolation-process determining unit 84 selects the first signal-interpolating unit 41a and the second signal-interpolating unit 41b for the pixels at which the flag FLG(i, j) is 1 and 3; selects the first signal-interpolating unit 41a for the pixels at which the flag FLG(i, j) is 0; and outputs this selected information to the interpolation processor 61. Also, together with the above-described selected information, the weighted summation coefficient K1 of the relevant pixel input from the second coefficient determining unit 87 is output for the pixels at which the flag FLG(i, j) is 1, and the weighted summation coefficient K2 of the relevant pixel input from the second coefficient determining unit 87 is output for the pixels at which the flag FLG(i, j) is 3.

Accordingly, in the interpolation processor 61, for the pixels at which the flag FLG(i, j) is 1 (i.e., the specified region), the second interpolated image signal S2 generated by the second signal-interpolating unit 41b and the first interpolated image signal S1 generated by the first signal-interpolating unit 41a are output to the combining unit 61a, and the combining process is performed in the combining unit 61a based on the weighted summation coefficient K1. The combining unit 61a outputs the combined signal as the combined interpolated image signal S3.

Also, for the pixels at which the flag FLG(i, j) is 0 (i.e., the region other than the specified region), the interpolation processing is performed by the first signal-interpolating unit 41a, and the first interpolated image signal S1 is generated.

Also, for the pixels at which the flag FLG(i, j) is (i.e., the surrounding region), the second interpolated image signal 32 generated by the second signal-interpolating unit 41b and the first interpolated image signal S1 generated by the first signal-interpolating unit are output to the combining unit 61a, the combining process is performed in the combining unit 61a based on the above-described weighted summation coefficient K2, and the signal is output as the combined interpolated image signal S4.

Here, since the weighted summation coefficient K2 is, as shown in (4) above, a value obtained by dividing the evaluation value by the value obtained by multiplying the maximum threshold value THmax by the gradient Grad, the weaker the correlation between the pixel of interest and the surrounding pixel is, in other words, the greater the gradient Grad is, the smaller the combinational fraction of the first interpolated image signal S1 becomes, and the larger the combinational fraction of the second interpolated image signal S2 becomes.

Then, by combining processed signals S1, S3, and S4, the color image signal is generated, and the color image signal is output to the second signal-processing unit 24 (see FIG. 1) in the subsequent stage.

As described above, with the color-interpolating unit 23d and digital camera according to this embodiment, since the surrounding region is defined as the combined interpolated image signal S4 that is generated by combining the first interpolated image signal S1 and the second interpolated image signal S2 at the combining ratio based on the evaluation value and the correlation between the pixel of interest and the surrounding pixel, it is possible to obtain an image having a smooth edge and a high resolution-maintaining effect.

The color-interpolation device and image processing system according to the present invention can be installed in products such as, for example, a broadcast stationary camera, an ENG camera, a consumer portable camera, a digital camera, and the like. Also, the color-interpolation device and image processing system may be used in an image signal interpolation program (CG program) for handling movies, an image editing device, and the like.

What is claimed is:

1. A color-interpolation device that generates an interpolated color image signal by interpolating a missing color component for a color image signal formed of pixels having a missing color component, comprising:
an interpolation processor that generates a first interpolated image signal and a second interpolated image signal by respectively performing first interpolation processing and second interpolation processing on the color image signal;
an evaluation-value calculating unit that calculates, for each pixel, an evaluation value for specifying a specified region which becomes the target of the first interpolation processing;
a region defining unit that defines the specified region on the basis of the evaluation value; and
an interpolation-process determining unit that generates the interpolated color image signal by extracting the image signal of the specified region from the first interpolated image signal, extracting the image signal of the region other than the specified region from the second interpolated image signal, and combining the extracted image signals.

2. A color-interpolation device that generates an interpolated color image signal by interpolating a missing color component for a color image signal formed of pixels having a missing color component, comprising:
an evaluation-value calculating unit that calculates, for each pixel, an evaluation value for specifying a specified region from the color image signal;
a region defining unit that defines a specified region on the basis of the evaluation value;
an interpolation-process determining unit that selects first interpolation processing to be used for the specified region and that selects second interpolation processing to be used for a region other than the specified region; and
an interpolation processor that generates the interpolated color image signal by performing the first interpolation processing on the specified region of the color image signal and by performing the second interpolation processing on the region other than the specified region.

3. A color-interpolation device according to claim 1, wherein the evaluation-value calculating unit obtains, the evaluation value by calculating the difference between the first interpolated image signal and the second interpolated image signal.

4. A color-interpolation device according to claim 2, wherein the evaluation-value calculating unit has a filter capable of calculating a value equivalent to the difference between the first interpolated image signal and the second interpolated image signal, and obtains the evaluation value by filtering the color image signal using the filter.

5. A color-interpolation device according to claim 1, wherein the interpolation processor filters the color image signal using a filter factor with a different characteristic.

6. A color-interpolation device according to claim 1, wherein the interpolation processor comprises:
a first signal-interpolating unit that performs interpolation processing by using a first interpolation filter configured with a filter factor having a frequency characteristic with which an approximately constant response is maintained from a low frequency to just before the Nyquist frequency of the image, and the response declines from just before the Nyquist frequency to the Nyquist frequency; and
a second signal-interpolating unit that performs interpolation processing by using a second interpolation filter configured with a filter factor having a frequency characteristic with which the response declines from a low frequency to the Nyquist frequency NF more gradually than the frequency characteristic of the first filter.

7. A color-interpolation device according to claim 1, wherein the region defining unit compares the evaluation value with the pre-registered predetermined threshold value and defines, on the basis of the comparison result, the specified region and the region other than the specified region.

8. A color-interpolation device according to claim 7, wherein the region defining unit specifies the specified region if the evaluation value is equal to or greater than the threshold value and defines the region other than the specified region if the evaluation value is less than the threshold value.

9. A color-interpolation device according to claim 8, wherein when the region defining unit has specified the pixel at which the evaluation value is equal to or greater than the threshold value as the center pixel, the region defining unit specifies surrounding regions having that center pixel as the center, and also defines the pixels in these surrounding regions as the specified region regardless of the evaluation value.

10. A color-interpolation device according to claim 6, wherein interpolation processing by a second signal-interpolating unit is performed on the specified region, interpolation processing by the first signal-interpolating unit is performed on the region other than the specified region, and the interpolated color image signal is generated by combining these interpolated image signals.

11. A color-interpolation device according to claim 6, wherein the interpolation-process determining unit causes the first signal-interpolating unit and the second signal-interpolating unit to perform the first interpolation processing; and causes the interpolation processor to combine the individual interpolated image signals thus generated at a combining ratio based on the evaluation value, thereby generating the interpolated color image signal in the specified region.

12. A color-interpolation device according to claim 9, wherein the interpolation processor comprises:
a first signal-interpolating unit that performs interpolation processing by using a first interpolation filter configured with a filter factor having a frequency characteristic with which an approximately constant response is maintained from a low frequency to just before the Nyquist frequency of the image, and the response declines from just before the Nyquist frequency to the Nyquist frequency; and
a second signal-interpolating unit that performs interpolation processing by using a second interpolation filter configured with a filter factor having a frequency characteristic with which the response declines from a low frequency to the Nyquist frequency NF more gradually than the frequency characteristic of the first filter;
wherein, the interpolation-process determining unit causes the first signal-interpolating unit and the second signal-interpolating unit to perform the second interpolation processing; and causes the interpolation processor to combine the individual interpolated image signals thus generated at a combining ratio based on the evaluation value and the correlation between the center pixel and the relevant pixel in the surrounding region, thereby generating the interpolated color image signal in the surrounding region.

13. An image processing system having the color-interpolation according to claim 1.

14. A color interpolation method for generating an interpolated color image signal by interpolating a missing color component for a color image signal formed of a pixel having a missing color component, comprising:
an interpolation processing step of generating a first interpolated image signal and a second interpolated image signal by respectively performing first interpolation processing and second interpolation processing on the color image signal;
an evaluation-value calculating step of calculating, for each pixel, an evaluation value for specifying a specified region which becomes the target of the first interpolation processing;
a region defining step of defining the specified region on the basis of the evaluation value; and
an interpolation-processing determining step of generating the interpolated color image signal by extracting the image signal of the specified region from the first interpolated image signal, extracting the image signal of the region other than the specified region from the second interpolated image signal, and combining the extracted image signals.

15. A color interpolation method for generating an interpolated color image signal by interpolating a missing color component for a color image signal formed of pixels having a missing color component, comprising:
an evaluation-value calculating step of calculating, for each pixel, an evaluation value for specifying a specified region from the color image signal;
a region defining step of defining a specified region on the basis of the evaluation value;
an interpolation-process determining step of selecting first interpolation processing to be used for the specified region and selecting second interpolation processing to be used for a region other than the specified region; and
an interpolation processing step of generating the interpolated color image signal by performing the first interpolation processing on the specified region of the color image signal and by performing the second interpolation processing on the region other than the specified region.

16. A computer-readable recording medium in which a color interpolation program that generates an interpolated color image signal by interpolating a missing color component for a color image signal formed of pixels having a missing color component is recorded, wherein the color interpolation program causes a computer to execute:
an interpolation processing step of generating a first interpolated image signal and a second interpolated image signal by performing first interpolation processing and second interpolation processing on the color image signal, respectively;
an evaluation-value calculation step of calculating, for every pixel, an evaluation value for specifying a specified region that becomes the target of the first interpolation processing;
a region defining step of defining the specified region based on the evaluation value; and
an interpolation-process determining step of extracting the image signal of the specified region from the first interpolated image signal; extracting an image signal of a region other than the specified region from the second interpolated image signal; and generating the interpolated color image signal by combining the extracted image signals.

17. A computer-readable recording medium in which a color interpolation program that generates an interpolated color image signal by interpolating a missing color component for a color image signal formed of pixels having a missing color component is recorded, wherein the color interpolation program causes a computer to execute:
an evaluation-value calculation step of calculating, for every pixel, an evaluation value for specifying a specified region from the color image signal;
a region defining step of defining the specified region based on the evaluation value;
an interpolation-process determining step of selecting first interpolation processing to be used for the specified region and selecting second interpolation processing to be used for the region other than the specified region; and
an interpolation processing step of generating the interpolated color image signal by performing the first interpolation processing on the specified region of the color image signal and performing the second interpolation processing on the region other than the specified region.

18. A color-interpolation device according to claim wherein the interpolation processor filters the color image signal using a filter factor with a different characteristic.

19. A color-interpolation device according to claim 2, wherein the interpolation processor comprises:
a first signal-interpolating unit that performs interpolation processing by using a first interpolation filter configured with a filter factor having a frequency characteristic with which an approximately constant response is maintained from a low frequency to just before the Nyquist frequency of the image, and the response declines from just before the Nyquist frequency to the Nyquist frequency; and
a second signal-interpolating unit that performs interpolation processing by using a second interpolation filter configured with a filter factor having a frequency characteristic with which the response declines from a low frequency to the Nyquist frequency NF more gradually than the frequency characteristic of the first filter.

20. A color-interpolation device according to claim 2, wherein the region defining unit compares the evaluation value with the pre-registered predetermined threshold value and defines, on the basis of the comparison result, the specified region and the region other than the specified region.

21. A color-interpolation device according to claim 19, wherein interpolation processing by the second signal-interpolating unit is performed on the specified region, interpolation processing by the first signal-interpolating unit is performed on the region other than the specified region, and the interpolated color image signal is generated by combining these interpolated image signals.

22. A color-interpolation device according to claim 19, wherein the interpolation-process determining unit causes the first signal-interpolating unit and the second signal-interpolating unit to perform the first interpolation processing; and causes the interpolation processor to combine the individual interpolated image signals thus generated at a combining ratio based on the evaluation value, thereby generating the interpolated color image signal in the specified region.

23. A color-interpolation device according to claim 20, wherein the region defining unit specifies the specified region if the evaluation value is equal to or greater than the threshold value and defines the region other than the specified region if the evaluation value is less than the threshed value.

24. A color-interpolation device according to claim 23, wherein when the region defining unit has specified the pixel at which the evaluation value is equal to or greater than the threshold value as the center pixel, the region defining unit specifies a surrounding region having that center pixel as the center, and also defines the pixels in this surrounding region as the specified region regardless of the evaluation value.

25. A color-interpolation device according to claim 24, wherein the interpolation processor comprises:
a first signal-interpolating unit that performs interpolation processing by using a first interpolation filter configured with a filter factor having a frequency characteristic with which an approximately constant response is maintained from a low frequency to just before the Nyquist frequency of the image, and the response declines from just before the Nyquist frequency to the Nyquist frequency; and
a second signal-interpolating unit that performs interpolation processing by using a second interpolation filter configured with a filter factor having a frequency characteristic with which the response declines from a low frequency to the Nyquist frequency more gradually than the frequency characteristic of the first filter;
wherein, the interpolation-process determining unit causes the first signal-interpolating unit and the second signal-interpolating unit to perform the second interpolation processing; and causes the interpolation processor to combine the individual interpolated image signals thus generated at a combining ratio based on the evaluation value and the correlation between the center pixel and the relevant pixel in the surrounding region, thereby generating the interpolated color image signal in the surrounding region.

26. An image processing system having the color-interpolation device according to claim 2.
